(19) United States
(12) Patent Application Publication
(10) Pub. No.: US 2024/0243803 A1
(43) Pub. Date: Jul. 18, 2024

(54) RADIO RELAY DEVICE AND RADIO RELAY METHOD

(71) Applicant: NTT DOCOMO, INC., Tokyo (JP)

(72) Inventors: Haruhi Echigo, Tokyo (JP); Shohei Yoshioka, Tokyo (JP); Shinya Kumagai, Tokyo (JP); Daisuke Kurita, Tokyo (JP); Yuki Takahashi, Tokyo (JP); Satoshi Nagata, Tokyo (JP)

(73) Assignee: NTT DOCOMO, INC., Tokyo (JP)

(21) Appl. No.: 18/559,211

(22) PCT Filed: May 10, 2021
(86) PCT No.: PCT/JP2021/017757

§ 371 Date: Nov. 6, 2023

(51) Int. Cl. H04B 7/155

(52) U.S. Cl. CPC H04B 7/1555

(57) ABSTRACT

The radio relay device receives control information from a radio base station. The radio relay device controls based on the control information, the relay state of at least a beam in relaying radio waves from a radio base station or a terminal without signal interpretation.

### TECHNICAL FIELD

The present invention relates to a radio relay device and a radio relay method.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

In particular, although high frequency bands are expected to be used in next-generation communications, improvements in communication quality are required from the points of reduction in the number of scatterers, reduction in the shadowing effect, and increase in distance attenuation, and beam control and environment that guarantee communication quality are expected to be required.

For example, in the high frequency band, there is a problem that a dead-zone is likely to occur due to the strong straightness of the radio wave. Therefore, a method to improve the communication quality in a multipath environment using a passive repeater or an active type reflector (RIS: Reconfigurable Intelligent Surface) has been tried (See Non-Patent Literature 1, pp. 15-16, etc.).

### CITATION LIST

### Non-Patent Literature

[Non-Patent Literature 1]

NTT DOCOMO, “DOCOMO 6G White Paper 3.0 Edition,” published [online], February 2021, Internet <URL: https://www.nttdocomo.co.jp/corporate/technology/whitepaper 6g/>

### DISCLOSURE OF INVENTION

When radio waves are reflected or transmitted from a radio wave source such as a base station or a terminal (User Equipment, UE) to a radio wave reception destination for relaying, it is necessary to obtain or estimate information on the propagation path between the base station and the UE or the like directly, and to appropriately control the beam of the reflector (RIS) or the like.

Accordingly, the present invention has been made in view of such a situation, and it is an object of the present invention to provide a radio relay device and a radio relay method capable of obtaining information on a propagation path or the like between a base station and a UE or the like and appropriately performing beam control of a reflector (RIS) or the like to relay the information.

A radio relay device (RIS 300), which is an aspect of the present disclosure, is provided with a control unit (control unit 330) that controls a relay state of at least a beam when radio waves from a radio base station (radio base station 100, 150) or terminal (UE200) are relayed without signal interpretation, and a reception unit (information acquisition unit 350) that receives control information from the radio base station (radio base station 100, 150). The control unit (control unit 330) controls the relay state of the beam based on the control information.

A radio relay method, which is an aspect of the present disclosure, includes the steps of controlling a relay state of at least a beam when radio waves from a radio base station (radio base station 100,150) or terminal (UE200) are relayed without signal interpretation, and receiving control information from the radio base station (radio base station 100,150). In the controlling step, the relay state of the beam is controlled based on the control information.

### BRIEF DESCRIPTION OF DRAWINGS

FIG. 1 is an overall schematic diagram of a radio communication system 10.

FIG. 2 is a basic diagram of a network using a radio relay device 300.

FIG. 3 is a functional block diagram of the radio relay device 300.

FIG. 4 is an explanatory diagram of a typical problem when a high-frequency band is used.

FIG. 5 is a diagram showing a relationship between a transmission antenna (Tx) of a base station 150 A, etc., a relay antenna (Sx) of a reflective radio relay device 300, and a reception antenna (Rx) of a UE200, etc.

FIG. 6 is a diagram showing a relationship between a transmission antenna (Tx) of the base station 150 A, etc., a relay antenna (Sx) of a transmissive radio relay device 300, and a reception antenna (Rx) of the UE200, etc.

FIG. 7 is a diagram showing a relationship between the radio relay device 300 and a base station 100 or the UE200 for signaling control information.

FIG. 8 is a diagram showing an example of selecting a beam to be transmitted and received by the RIS in the Meta Structure.

FIG. 9 is a diagram showing an example of selecting a beam to be transmitted and received to the RIS in the Meta Structure.

FIG. 10 is a diagram showing an operation example of the radio relay device 300.

FIG. 11 is a diagram showing an operation example of the radio relay device 300.

FIG. 12 is a diagram showing an operation example of the radio relay device 300.

FIG. 13 shows an operation example of the radio relay device 300.

FIG. 14 shows an operation example of the radio relay device 300.

FIG. 15 shows an example of a hardware configuration of the UE200 and the radio relay device 300.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

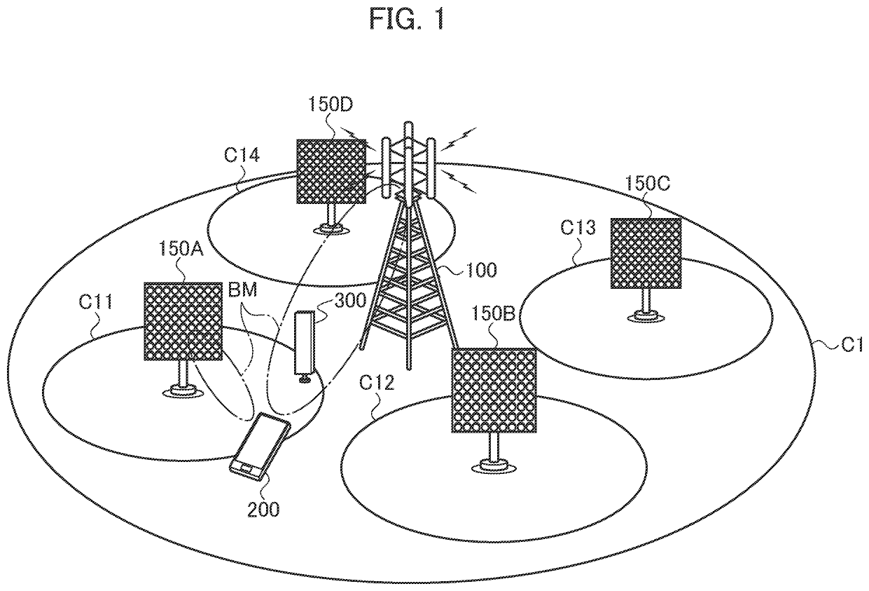

FIG. 1 is an overall schematic configuration diagram showing an example of the radio communication system 10 according to the present embodiment. The radio communication system 10 is, for example, a radio communication system according to 5G New Radio (NR) or 6G, and comprises a plurality of radio base stations and a plurality of terminals.

Specifically, the radio communication system 10 includes a radio base station 100, radio base stations 150 A to 150 D, and a user terminal 200 (UE200, User Equipment).

The radio base station 100 is a radio base station according to 5G to 6G as an example, and forms cell C1. The cell C1 is a relatively large cell and is called a macrocell.

The radio base stations 150 A to 150 D are also radio base stations according to the 5G to 6G, but relatively small cells C11 to C14 are formed respectively. The cells C11 to C14 may be referred to as small cells or semi-macro cells. As shown in FIG. 1, the cells C11 to C14 may be formed to be included (overlaid) in cell C1 (macro cell).

A macrocell is generally interpreted as a communicable area with a radius of several hundred meters to several tens of kilometers covered by a single radio base station. A small cell is also interpreted as a generic term for a cell that has a small transmission power and covers a small area compared to a macrocell.

The radio base station 100 and the radio base stations 150 A to 150 D may be referred to as a gNodeB (gNB) or a BS (Base Station). The UE200 may be referred to as an MS or the like. Further, the specific configuration of the radio communication system 10 including the number and types of radio base stations and terminals is not limited to the example shown in FIG. 1.

Also, the radio communication system 10 is not necessarily limited to radio communication system according to 5G to 6G. For example, the radio communication system 10 may be a 6G next-generation radio communication system or a radio communication system according to Long Term Evolution (LTE).

The radio base station 100 and the radio base stations 150 A to 150 D perform radio communication according to 5G to 6G with the UE200 as an example. The radio base station 100 and the radio base stations 150 A to 150 D and the UE200 can support Massive MIMO to generate a more directional beam BM by controlling radio signals transmitted from multiple antenna elements; Carrier Aggregation (CA) to bundle multiple component carriers (CCs); Dual Connectivity (DC) to communicate simultaneously between the UE and each of the two NG-RAN Nodes; and Integrated Access and Backhaul (IAB) to integrate radio backhaul between radio communication nodes such as gNB and radio access to the UE.

The radio communication system 10 can also support higher frequency bands than the following frequency ranges (FRs) specified in 3GPP Release 15:
FR1: 410 MHz˜7.125 GHZ
FR2: 24.25 GHz˜52.6 GHz

Specifically, the radio communication system 10 supports frequency bands above 52.6 GHz and up to 114.25 GHz. Here, such high frequency bands are referred to as “FR 4” for convenience. FR4 belongs to the so-called EHF (extremely high frequency, also called millimeter wave). Note that FR4 is a tentative name and may be called by another name.

The radio communication system 10 includes a radio relay device 300. In this embodiment, as an example, the radio relay device 300 may be described as a reflector (RIS), a phase control reflector, a passive repeater, an IRS (Intelligent Reflecting Surface), and the like. A specific example of a reflector (RIS) may be a metamaterial reflector, a dynamic metasurface, a metasurface lens, and the like (see Non-Patent Literature 1).

In this embodiment, the radio relay device 300 relays a radio signal transmitted from a radio base station (For example, radio base station 150 A) (In the description of the present embodiment, at least one of “reflection,” “transmission,” “aggregation” (concentrating radio waves at approximately one point) and “diffraction” may be referred to as “relay”.). The UE200 can receive a radio signal relayed by the radio relay device 300. Conversely, the radio relay device 300 may relay a radio signal transmitted from the UE200. The same is true for the base station 100 (including base stion 150. Same as below). That is, the radio relay device 300 relays radio signals from the radio base station 100 or the terminal 200.

As an example, the radio relay device 300 can change the phase of radio signals relayed to the terminal 200. In this light, the radio relay device 300 may be referred to as a phase-variable reflector. In the present embodiment, the radio relay device 300 may be described as having a function of relaying a radio signal by changing its phase, but this is not limited to the above. The radio relay device 300 may be referred to as a repeater, a repeater, a reflect array, IRS, or a transmit array.

In this embodiment, the radio relay device 300 such as RIS may be referred to as a battery less device, a metamaterial function device, an intelligent reflecting surface, a smart repeater, or the like. As an example, the radio relay device 300 such as RIS may be defined as having the following functions.

### (Ue Features)

Function for receiving signals sent from the BS (Examples: DL (downlink) signal, SSB (SS Block), PDCCH (Physical Downlink Control Channel), PDSCH (Physical Downlink Shared Channel), DM-RS (DeModulation Reference Signal), PT-RS (Phase Tracking Reference Signal), CSI-RS (Channel Status Information Reference Signal), RIS-only signal)

Receiving information related to the following metamaterial functions
Transmitting signal to BS (Examples: UL (uplink) signal, PRACH (Random Access Channel Preamble), PUCCH (Physical Uplink Control Channel), PUSCH Physical Uplink Control Channel, DM-RS, PT-RS, SRS (Sounding Reference Signal), RIS-only signal)

Transmitting information related to the following metamaterial functions
Frame synchronization function with BS

### [Metamaterial Function]

Reflection function for signals sent from BS or UE (e.g., phase change)

Beam control function (Examples: Transmission Configuration Indication (TCI)-state, functions related to controlling Quasi Co Location (QCL), selective application of beam, selective application of spatial filter/precoding weight)
Power change function for signals sent from BS or UE (e.g., power amplification)

Further, “receive and transmit” and “relay” in the radio relay device 300 such as RIS may mean that the following predetermined function A is performed, but the following predetermined function B is not performed and transmitted.
A: phase shifter is applied, but B: compensation circuit (e.g. Amplification, Filter) is not involved.
A: phase shifter and compensation circuit are applied, but
B: frequency conversion is not involved.

When the phase is changed in the radio relay device 300 such as RIS, the amplitude may be amplified. The term “relay” in the radio relay device 300 such as RIS may mean that the received signal is transmitted as it is without processing at the layer 2/3 level, that the received signal is transmitted as it is at the physical layer level, or that the received signal is transmitted as it is without signal interpretation (At this time, the phase may be changed or the amplitude may be amplified.). In this embodiment, in particular, the radio relay device 300 can control the relay state of at least a beam when the radio wave from the radio base station 100 or the terminal 200 is relayed without signal interpretation.

### (2) Basic Configuration of a Network Using the Radio Relay Device 300

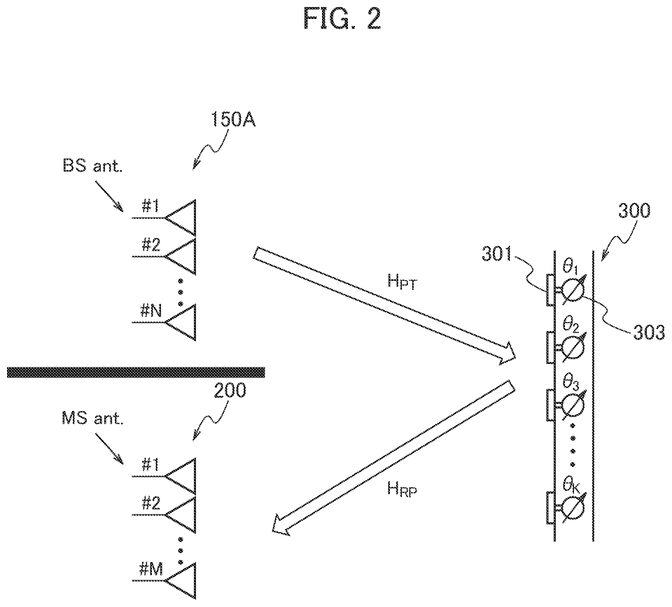

Next, the basic configuration of the network using the radio relay device 300 will be described. FIG. 2 is a basic configuration diagram of the network using the radio relay device 300.

As shown in FIG. 2, as an example, the radio relay device 300 interposes between the radio base station 150 A (which may be another radio base station 100 or the like) and the UE200, and relays (Reflection, transmission, aggregation, diffraction, etc.) radio signals transmitted and received between the radio base station 150 A and the UE200.

As a specific example, when the radio quality is good, the radio base station 150 A and the UE200 directly transmit and receive radio signals without going through the radio relay device 300. When the radio quality deteriorates, such as when there is a shield between the radio base station 150 A and the UE200, the radio relay device 300 relays the radio signals transmitted and received between the radio base station 150 A and the UE200.

Specifically, the radio relay device 300 estimates the propagation path information H_{PT}, H_{RP} between the relay antenna and the radio wave source such as the radio base station 150 A and the UE200 based on the change in the received power when a variable unit 303 such as the variable phase unit is controlled, and relays the radio signals to the radio wave reception destination such as the UE200 by controlling the variable unit 303 such as the variable phase unit based on the estimated propagation path information. The radio relay device 300 may also relay the radio signals to the radio wave reception destination such as the UE200 based on the control information received from the radio base station 150 A or the UE200 by controlling the variable unit 303 such as the variable phase unit.

Here, the propagation path or the propagation channel is an individual communication path of the radio communication, and in this case, it is a communication path between the transmission/reception antennas (BS ant., MS ant., etc.).

As an example, the radio relay device 300 includes a small multi-element antenna 301 that supports Massive MIMO, a variable phase or phase shifter 303 that changes the phase of the radio signal, in effect, the phase of the radio wave to a specific phase, and uses the phase shifter 303 to control the phase of the radio wave relayed to the UE200 or the radio base station 150 A. Specific control methods of the phase may be referred to the following references.

Venkat Arun and Hari Balakrishnan, “RFocus: Beamforming Using Thousands of Passive Antennas,” 17th USENIX Symposium on Networked Systems Design and Implementation (NSDI '20), Feb. 25-27, 2020, Santa Clara, CA, USA, pp. 1047-1061

Qingqing Wu, and Rui Zhang, “Intelligent Reflecting Surface Enhanced Radio Network via Joint Active and Passive Beamforming,” IEEE TRANSACTIONS ON RADIO COMMUNICATIONS, VOL. 18, NO. 11, NOVEMBER 2019, pp. 5394-5409

### (3) Functional Block Structure of the Radio Relay Device 300

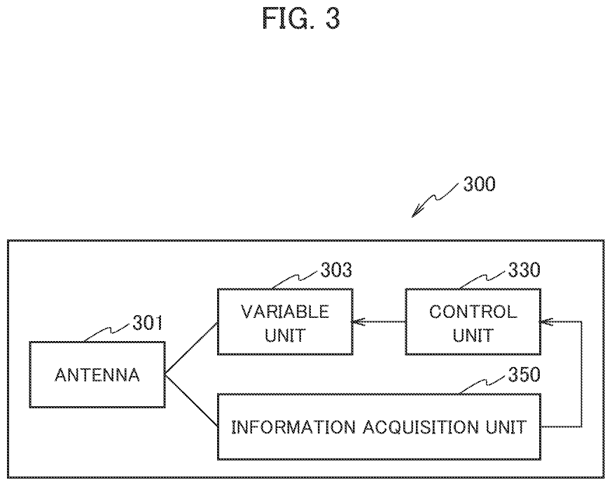

FIG. 3 is a functional block structure diagram of the radio relay device 300. As shown in FIG. 3, the radio relay device 300 includes an antenna 301, a variable unit 303, a control unit 330, and an information acquisition unit 350.

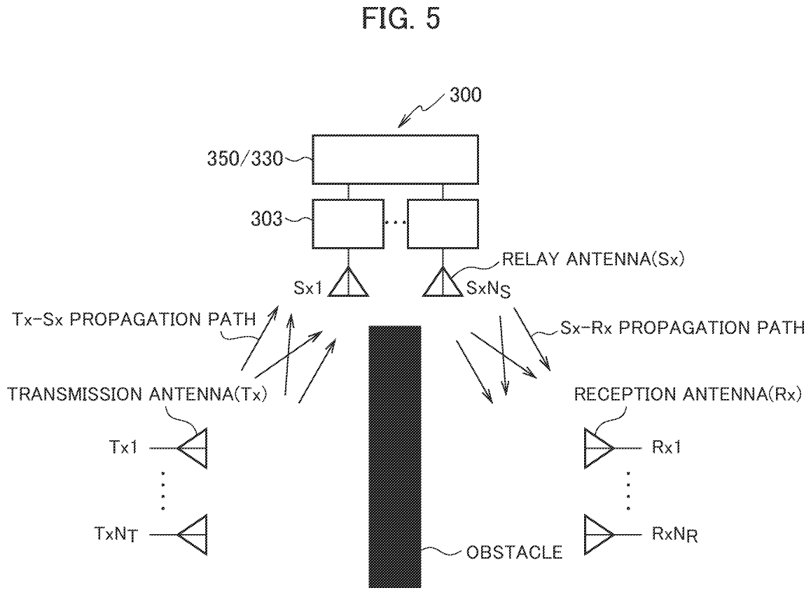

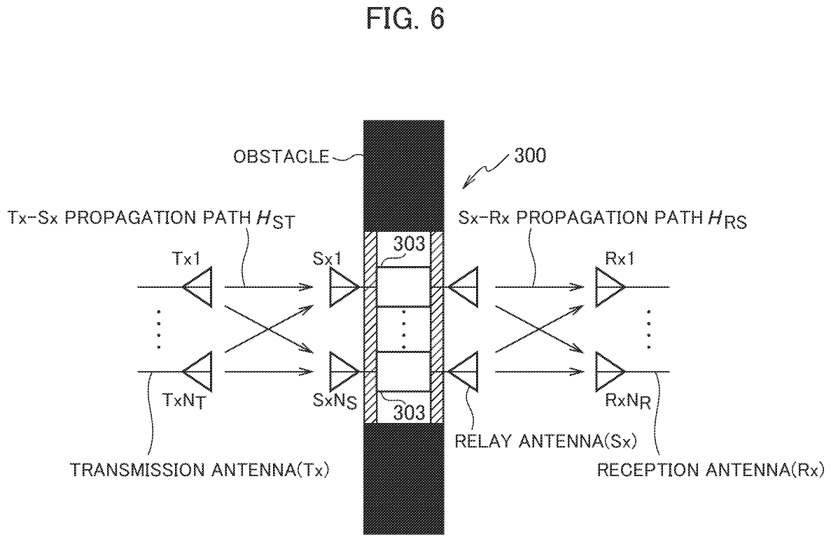

The antenna 301 includes at least one antenna connected to the variable unit 303, as will be described later with reference to FIGS. 5 and 6. For example, the antenna 301 may be arranged as an array antenna. In this embodiment, the antenna 301 may be specifically referred to as a relay antenna.

The variable unit 303 is connected to the antenna 301 and can change the phase, load, amplitude, etc. For example, the variable unit 303 may be a variable phase unit, a phase shifter, an amplifier, etc. For example, by changing the phase of the radio wave that has reached the relay antenna from the radio wave generation source, the direction of the radio wave, the beam or the like can be changed.

The control unit 330 is a control means for controlling the variable unit 303. In the present embodiment, the control unit 330 functions as a control unit for controlling the relay state of at least a beam when radio waves from the radio base station 100 or the terminal 200 are relayed without signal interpretation. Here, control unit 330 may change the relay state based on the control information received from the radio base station 100. For example, the control unit 330 may select an appropriate receiving beam and transmission beam (orientation) based on the control information such as the SSB, and thus control the variable unit 303. The control information may be a combination of a beam between the radio base station 100 and the radio relay device 300 and a beam between the UE200 and the radio relay device 300 (For example, mapping information of the former and the latter).

In the present embodiment, the control unit 330 can control the variable unit 303 based on, for example, information about the propagation path between the UE200 or the radio base station 150 A and the relay antenna 301 (Including information estimated by the reception state and control information, as follows). For example, control unit 330 can relay the radio wave received from the radio base station 150 A in a specific direction such as the radio wave reception destination (in this case, the UE200) by changing the phase without using the transmission power using a known technique such as an active repeater or RIS. Specifically, the control unit 330 controls the phase of the radio signal for relaying to UE200 or radio base station 150 A based on the estimated H_{PT} and H_{Rp}. That is, the radio wave can be relayed to a specific direction by changing the phase of array antenna or the like in the same principle as beamforming or the like. Note that the radio relay device 300 controls (changes) only the phase of the radio signal (radio wave) by the control unit 330, and may be relayed without power supply without amplifying the power of the relayed radio signal.

Here, in this embodiment, the control unit 330 may determine whether the control information received by the reception unit 350 is addressed to it. For example, the RIS 300 may determine whether the control information (such as DCI) is addressed to it by the RNTI (Radio Network Temporary Identifier) that scrambles the DCI's CRC (cyclic redundancy Inspection). As another example, the RIS 300 may determine which of the fields, such as DCI, is addressed to it based on the configurations of the higher layer.

Further, in this embodiment, the control unit 330 may control the time until the change of the relay state related to the beam based on the control information, and may control the application period of the control of the relay state related to the beam based on the control information. Specific examples will be described later.

In the present embodiment, the information acquisition unit 350 functions as a reception unit for acquiring control information from the radio base station 150 A. For example, the information acquisition unit 350 may receive various signals (including various signals exemplified by the UE function and metamaterial function described above.), such as SSB, transmitted from the radio base station 150 A or the UE200 as control information. In this embodiment, the information acquisition unit 350 may receive configuration information for receiving control information about the beam. In this embodiment, the information acquisition unit 350 may function as a transmission unit for transmitting response information to the reception of control information to the radio base station 100. The information acquisition unit 350 may estimate the propagation path information (H_{PT}, H_{RP}) between the radio wave source (Example: Radio base station 150 A, UE200) and the relay antenna 301 based on the reception state (e.g., change in the received power, etc.) during the control of the variable unit 303.

The H_{PT} and H_{RP} may be expressed as follows.

$${H}_{PT} ∈ {ℂ}^{K \times N} \qquad [ Number 1 ]$$

$${H}_{RP} ∈ {ℂ}^{M \times K}$$

M is the number of antennas at the terminal (receive), N is the number of antennas at the radio base station (transmit), and K is the number of relay antennas.

Concretely, the propagation path information (propagation channel information) about each propagation path is information such as amplitude and phase, and in this embodiment, is information estimated about the propagation path of radio waves arriving at the relay antenna 301. As an example, the information acquisition unit 350 may estimate the propagation path information of the relay antenna 301 based on the change in the received power when the phase of the variable unit 303 of each arrayed relay antenna 301 is switched orthogonally in the Same principle as I/Q (In-phase/Quadrature) detection.

### (4) Example of Configuration of Antennas, Etc.

Next, an example of configuration centering on the relay antenna 301 will be described. A typical problem in the case where a high-frequency band is used will be described, and an example of an antenna configuration in the radio relay device 300, which can eliminate the problem, will be described.

### (4.1) Problems

A radio base station that supports Massive MIMO can transmit beams. In general, Massive MIMO means MIMO communication using an antenna having 100 or more antenna elements, which enables radio communication at higher speeds than before due to the multiplexing effect of multiple streams. Advanced beamforming (BF) is also possible. The beamwidth can be dynamically changed depending on the frequency band used, the state of the UE200, etc. In addition, the received signal power can be increased by the beamforming (BF) gain by using a narrow beam. In addition, effects such as reduction of applied interference and effective utilization of radio resources can be expected.

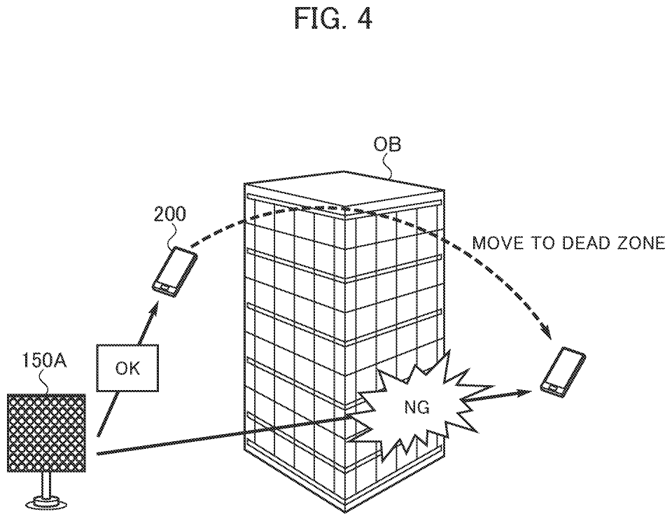

FIG. 4 is an explanatory diagram of a typical problem when using a high-frequency band. As shown in FIG. 4, when a high frequency band of several GHz to several tens of GHz or more is used, a dead zone is likely to occur due to the strong straightness of the radio wave. When the radio base station 150 A and the UE200 can be seen, the radio communication between the radio base stations 150 A and the UE200 is not affected even when the high frequency band is used. On the other hand, when the sight between the radio base station 150 A and the UE200 is blocked by an obstacle OB, such as a building or a tree, for example, the radio quality deteriorates significantly. In other words, when the UE200 moves to the dead zone which is blocked by the obstacle OB, communication may be interrupted.

Considering the existence of applications (remote control, etc.) which take advantage of the high speed and high capacity and low delay characteristics of 5G to 6G, it is important to eliminate the dead zone and keep the connection between the radio base station and the terminal without interruption of communication in the radio communication system 10.

Therefore, technologies that can relay radio waves between the base station 150 A and the UE200, such as active repeaters and radio wave propagation controllers such as RIS, have been developed. Thus, the communication characteristics can be improved by controlling the propagation characteristics of the base station signals, and the coverage can be expanded without the need for a signal source, and the installation and operation costs can be reduced by the expansion of the base station.

Conventional radio wave propagation control devices include a passive type and an active type. The passive type has the advantage of not requiring control information, but cannot follow a moving object, environmental fluctuation, etc. On the other hand, the active type has the disadvantage of requiring control information and increasing overhead, but can variably control the propagation characteristics of radio waves by changing the load (phase) state of the control antenna, and can follow a moving object, environmental fluctuation, etc.

There are two types of active type radio wave propagation controllers and control methods: feedback (FB) norms and propagation path information norms. In FB norms, a variable type radio wave propagation controller asks a UE or the like to feedback the communication state when the load (phase) state is randomly changed, and searches for the optimum condition. On the other hand, in propagation path information norms, the load state is determined based on the propagation path information between the radio base station and the radio wave propagation controller, and the optimum radio wave propagation control becomes possible. In this embodiment, any type can be applied.

Further, there are types of relay methods such as reflection, transmission, diffraction, aggregation, etc. In this embodiment, as an example, a configuration example of reflection type and transmission type will be described below (refer to Non-Patent Literature 1, etc. for diffraction type and aggregation type).

### (4.2) Reflective Type

An example of the system configuration of the reflective radio relay device 300 will be described with reference to FIG. 5. FIG. 5 is a diagram showing the relationship between a transmission antenna (Tx) of the base station 150 A, etc., a relay antenna (Sx) of the transmissive radio relay device 300, and a reception antenna (Rx) of the UE200, etc. As shown in FIG. 5, in the present embodiment, MIMO is used as an example, and there are a plurality of propagation paths between Tx-Sx and a plurality of propagation paths between Sx-Rx, and the radio relay device 300 controls a variable unit 303 such as a variable phase unit of the antenna 301 to relay radio waves.

As shown in FIG. 5, in the case of the reflection type, the array type relay antennas 301 are arranged facing the same direction. Thus, the propagation path of the relay antennas 301 can be estimated based on the reception state observed when the phase conditions of the relay antennas 301 are changed in a plurality of ways.

### (4.3) Transmission Type

An example of the system configuration of the transmission type radio relay device 300 will be described with reference to FIG. 6. FIG. 6 is a diagram showing the relationship between a transmission antenna (Tx) of the base station 150 A, etc., a relay antenna (Sx) of the transmission type radio relay device 300, and a reception antenna (Rx) of the UE200, etc. As shown in FIG. 6, in the present embodiment, MIMO is used as an example, and there are a plurality of propagation paths between Tx-Sx and a plurality of propagation paths between Sx-Rx, and the radio relay device 300 relays the radio wave arriving from one side to the other side via a variable unit 303 such as a variable phase unit of the relay antenna 301, as shown. Thus, in the case of the transmission type, the reference antenna 301 A and the relay antenna 301 are arranged in a pair so as to be directed in opposite directions so as to be able to relay the radio wave arriving from one side to the other side. In the case of the transmission type or the reflection type, the reception state may be measured by a power detector or the like so as to detect the power arriving at the relay antenna 301. In addition, the propagation path of the relay antenna 301 can be estimated based on the received signal observed when the phase conditions of the relay antenna 301 are changed plural times.

### (5) Example of Control Using Control Information

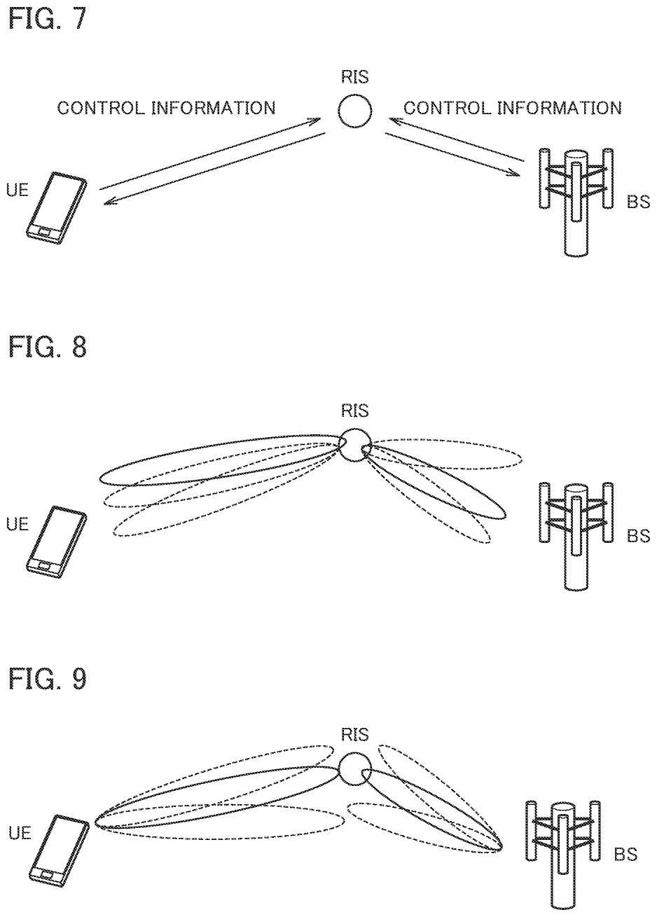

An example of a method by which the radio relay device 300 controls the relay state of a beam based on control information received from the base station 100 will be described below with reference to FIGS. 7 to 9.

FIG. 7 is a diagram showing a relationship between the radio relay device 300 and the base station 100 or UE200 for signaling control information. In this embodiment, as shown in FIG. 7, signaling is performed between the radio relay device 300 and the base station 100 or UE200 in order to control the beam of the radio relay device 300 such as RIS. For example, control information for beam selection is included in the transmitted/received signal, and the reception quality of the transmitted beam is fed back.

An example of beam control in which the beam is changed by the control information without changing the beam of the base station will be described below. FIGS. 8 and 9 show an example of selecting the beam to be transmitted and received by the RIS in the control information.

As shown in FIG. 8, the beam selection of the control information enables the RIS 300 to appropriately select the beam to be transmitted and received by itself. Also, as shown in FIG. 9, the base station 100 or the UE200 can appropriately select the beam to be directed when transmitting to the RIS or the beam to be received from the RIS.

### (6) Example of RIS Operation

Next, an example of operation of the radio relay device 300 such as RIS will be described below. In the present embodiment, as shown in FIG. 7, the operation of communicating control information between the base station and the RIS and determining the operation of the RIS based on the control information will be described.

In the operation, at least one of the following may be performed.
Discovery
Synchronization/Connection with Base Station
Synchronization/Connection with Mobile Station
Synchronization/Connection between Base Station and Mobile
Station
Beam Selection Based on Information from Base Station
Beam Selection Based on Information from Mobile Station
Feedback Specifications Associated with Meta Structure
Control
Signaling mechanism for controlling RIS beam
Beam selection by RIS
Beam switching in the presence of multiple mobile stations
Cooperation by multiple RIS
Communication quality report to base station/mobile station

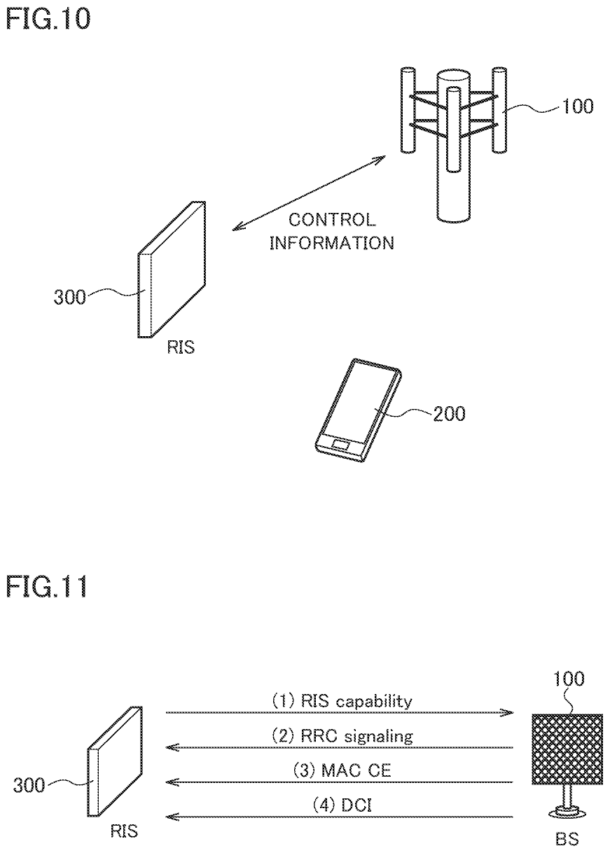

FIG. 10 is a diagram showing an operation example of the radio relay device 300 in this embodiment. As shown in FIG. 10, in this embodiment, the radio relay device 300 such as RIS controls the relay state of the relay beam based on the control information received from the base station 100. The radio relay device 300 may perform the following operations as an initial connection procedure with the radio base station 100.
discovery
   RIS may discover synchronous/connectable base stations.
   RIS may discover synchronous/connectable base stations.
Synchronous/connected: RIS performs
   synchronous/connectable operations with base stations. For example, RIS synchronizes based on SSBs sent from base stations and transmits connection requests to base stations.
Initial connection between base stations and mobile stations: Receive and transmit signals related to the initial connection sent from base stations and mobile stations (beam control in RIS)
   For example, RIS directs the beam according to each SSB index

The radio relay device 300 may perform the following operations when performing beam control (beam control based on control information from the base station) in communication after establishing a connection between the base station and the mobile station. The beam control may be performed UE-specific.
RIS receives and decodes control information from the base station.
   For example, in order to perform beam control, RIS may receive and decode CSI information and position information of mobile and base stations from the base station.
RIS performs beam control based on the control information received and decoded from the base station.
   For example, beam switching in the presence of multiple mobile stations
RIS reports communication information to the base station For example, RIS reports communication quality on the RIS side to the base station

### (7) Semi-Static (Semi-Static) RIS Beam Selection

An example of RIS beam selection by a base station using control information will be described below, focusing on the following points.
Proposal 1: Beam selection based on the value set in RRC
Proposal 2: Beam selection based on the received MAC CE
Proposal 3: Beam selection based on the received DCI
Proposal 3-1: RIS scramble the CRC of the DCI. RNTI may determine if the DCI is addressed to it.
Proposal 3-2: RIS may determine which of the fields in the DCI are addressed to it based on the configuration of the higher layer.
Proposal 4: Time until RIS applies the beam change.
Proposal 4-1: Time until beam application based on received beam information.
Proposal 4-2: Time for beam change/frequency difference required to simultaneously direct different beams.
Proposal 5: Application Period for Received Beam Selection Information
Proposal 5-1: The beam selected based on the received information may be used until predetermined conditions are met
Proposal 5-2: A predetermined operation may be performed after predetermined conditions are met
Proposal 6: Configuration for receiving information for beam selection
Proposal 7: Response to receiving information for beam selection

FIG. 11 shows an example of operation between the RIS 300 and the base station 100. As shown in FIG. 11 (1), in Step 1, the RIS reports information about a beam that can be directed to the UE to the base station. For example, the capability information (Capability) of the RIS is reported to the base station (Example: number of beams that RIS can point to, direction or angle of beams that RIS can point to).

(2) As Step 2, beam selection by RRC is performed based on the control information from the base station. The RIS may receive the beam selection information by the higher layer signal as the control information, and select the beam based on the parameter set by RRC.

(3) As Step 3, the RIS receives the beam selection information by the MAC CE as the control information. For example, the RIS receives the beam selection information by the MAC CE as the control information. At this time, the RIS may select the beam based on the beam selection information set by the RRC and the MAC CE.

(4) As Step 4, the RIS receives the beam selection information by the DCI. For example, the RIS may receive the beam selection information by the DCI as control information. At this time, the RIS may select the beam based on the beam selection information set by the RRC/MAC CE and the DCI. Note that a group common or RIS-specific RNTI dedicated to RIS or the same RNTI as UE may be set.

Note that any of the above steps need not be applied. Further, the beam relay is a process of converting the phase of the received signal to a specific phase, which may be referred to as spatial filter and weight.

### (7.1) Proposal 1

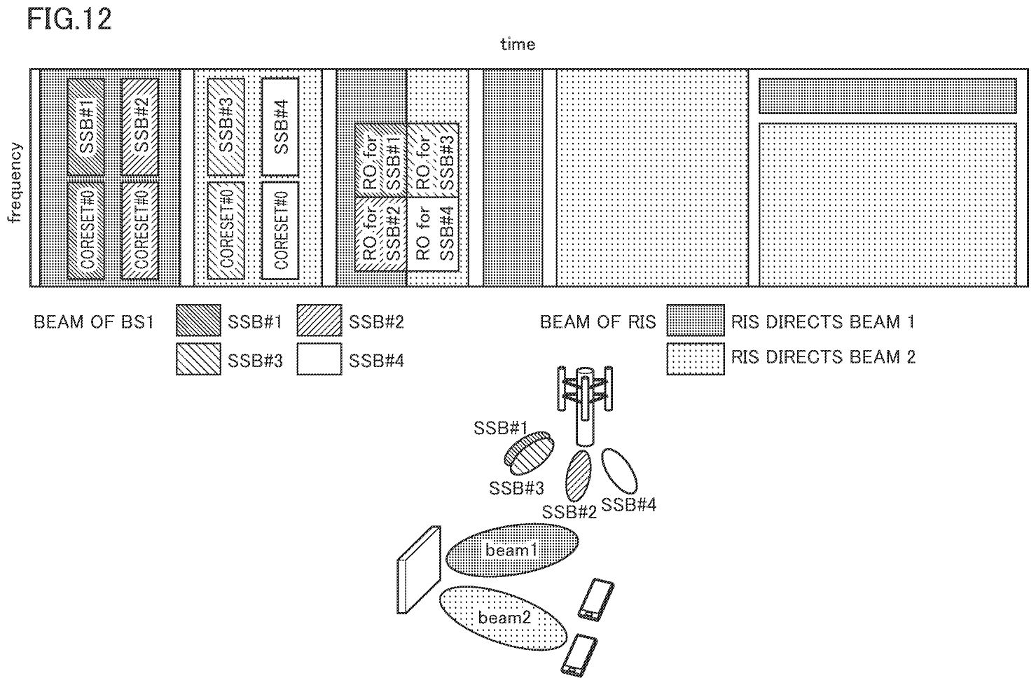

An example of beam selection based on the value set in RRC will be described with reference to FIG. 12. The RIS may receive information related to beam selection from the base station as control information in the higher layer signal.

The beam selection may be performed based on the value set in the RRC. For example, the following information may be received to select a beam:

The RIS may also select a beam based on the beam pattern information for a specific period of time. For example, one or more beam patterns between SSB periodicity, TDD pattern, several radio frames/slot/symbols may be set, and a beam may be selected based on one beam pattern. RIS may also report the number of configurable beam patterns.

At this time, as shown in FIG. 12, beam patterns differing in frequency may be set. For example, a beam pattern as shown in FIG. 12 may be set in the representation of a bitmap or SLIV. That is, as shown in FIG. 12, when there are many UEs in the direction of beam 2, many resources of beam 2 can be set.

### (7.2) Proposal 2

An example of beam selection based on the MAC CE received as control information will be described. The RIS may receive the MAC CE and select the beam based on the received MAC CE.

The RIS may report to the base station whether the beam selection based on the MAC CE is possible. The RIS may select the beam based on the plurality of beam patterns set by the RRC and the received MAC CE.

One or more specific beam patterns may be activated/deactivated. The RIS may also report the number of activatable beam patterns. At this time, beam selection based on the received MAC CE may be performed only for a certain period after reception. The specific period may be determined based on a given rule/RRC configuration/MAC CE.

The RIS may select a beam by changing a part of the beam pattern received by the RRC based on the MAC CE. The beam is selected based on the MAC CE holding the beam information at a specific time/frequency. At this time, the beam selection based on the received MAC CE may be performed only for a certain period after the reception, and the specific period may be determined based on the predetermined rule/RRC configuration/MAC CE.

### (7.3) Proposal 3

An example of beam selection based on the received DCI as control information will be described below.

As an example, the RIS may receive the DCI and select the beam based on the received DCI. The RIS may also report to the base station whether beam selection based on DCI is possible. The RIS may select a beam based on a plurality of beam patterns activated by the MAC CE and the received DCI.

At this time, the beam selection based on the received DCI may be performed only for a certain period after the reception. The specific period may be determined based on the predetermined rule/configuration of RRC/MAC CE/DCI.

The RIS may select a beam by changing a part of the beam pattern received by RRC based on DCI. The beam may be selected based on DCI which holds the beam information at a specific time/frequency. At this time, the beam may be selected based on the received DCI only for a certain period after the reception. The specific period may be determined based on the predetermined rule/configuration of RRC/MAC CE/DCI.

### (7.3.1) Proposal 3-1

The RIS may be determined by the RNTI that scrambles the CRC of the DCI. The RIS may be determined by the RNTI that identifies one RIS.

The RIS may be determined by the RNTI that identifies multiple RIS. The RNTI that identifies the RIS may be shared with the UE, or an RNTI dedicated to the RIS may be used.

### (7.3.2) Proposal 3-2

The RIS may determine which of the fields in the DCI are addressed to it based on the configuration of the higher layer.
Option 1: Configure a group at a higher layer and determine that the field in the RNTI scrambled DCI corresponding to the configured group is addressed to you
Option 2: Configure each DCI format at a higher layer and determine that the field in the RNTI scrambled DCI is addressed to you.

### (7.4) Proposal 4

An example of a control on the time until RIS applies a beam change is described below.

### (7.4.1) Proposal 4-1

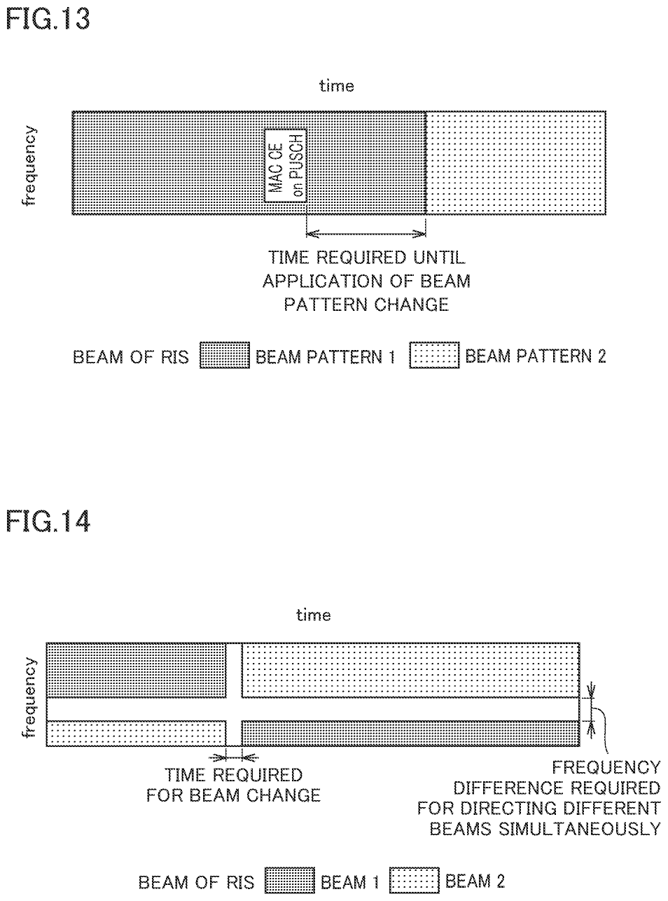

As shown in FIG. 13, the time until beam application based on the received beam information may be set and reported according to the RRC, MAC CE, and DCI. The RIS may apply the information based on the received beam after a certain time. The RIS may determine the time to beam application based on the received beam information based on a given rule or RRC configuration or MAC CE or DCI.

The RIS may report the time it takes to apply the received beam-based information after it is received. The RIS may report the time to apply the beam based on the received beam information in the RRC or MAC CE.

### (7.4.2) Proposal 4-2

The time to beam change/the frequency difference required to simultaneously direct different beams will be described with reference to FIG. 14.

The RIS may report the time required to switch the beam (e.g., RRC or MAC CE). The RIS may report the frequency difference required to simultaneously direct different beams (Example: RRC, MAC CE). The time required to change the beam/the frequency difference required to simultaneously direct different beams may be determined based on a predetermined rule (e.g., the RIS operates to avoid the time required to change the beam).

### (7.5.1) Proposal 5

The application period of the received beam selection information will be explained. In this example, the beam selected based on the received information may be used until a predetermined condition is satisfied.
Example. Until the next time information for beam selection is received
Example. Until the connection between the base station and the RIS is no longer maintained
Example. From receiving information for beam selection or beam selection/change based on received information, timer is started until a predetermined time has elapsed. When receiving information for beam selection or beam selection/change based on the received information while the timer is moving, the timer may be reset.

### (7.5.2) Proposal 5-2

After the predetermined conditions are satisfied, the predetermined operation may be performed.
Example. May be changed to a given beam (e.g. default)
Example. The function of receiving and transmitting signals from the base station may be stopped.
Example. A predetermined signal may be transmitted to the base station, and it may be a signal reporting that a predetermined condition has been met.

### (7.6) Proposal 6

A configuration for PDCCH reception relating to information for beam selection may be received from the base station.
Example. Configurations related to CORESET/Search Space/Monitoring Occasion may be used.
Example: Configurations related to receiving information other than information for beam selection may be common or different.

### (7.7) Proposal 7

A signal may be transmitted to the base station for receiving information for beam selection.
Example. DCI for receiving information for beam selection may include information (slot/resource) for response transmission.
Example. The slot/resource associated with the response transmission may be determined based on the timing of information reception for beam selection, or based on the timing of completion of beam selection/change.
Example. Response transmission may occur in PUCCH, may occur in PUCCH, and may not be limited to

### (8) Operational Effects

According to the above-described embodiment, the following effects can be obtained. That is, the radio relay device (RIS 300) is provided with a control unit (control unit 330) that controls the relay state of at least a beam when radio waves from a radio base station (radio base station 100,150) or a terminal (UE200) are relayed without signal interpretation, and a reception unit (information acquisition unit 350) that receives control information from the radio base station (radio base station 100, 150), and control unit (control unit 330) controls the relay state of the beam based on the control information.

As a result, the radio relay device 300 can obtain information on a propagation path or the like between the base station and the UE or the like by acquiring control information on the beam from the radio base station, and appropriately control the reflector (RIS) or the like to relay the beam.

In addition, in this embodiment, the radio relay device 300 determines whether the received control information is addressed to itself, so that even when a plurality of RIS or the like exist around the base station, it can give instructions only to the target radio relay device.

In addition, in this embodiment, since the time until the relay state of the beam is changed based on the control information is controlled, beam relay can be performed appropriately according to the capability of the RIS or the like.

In addition, since this embodiment controls the application period of the control of the relay state of the beam based on the control information, beam relay can be performed appropriately according to the capability of the RIS or the like.

In addition, since this embodiment receives the configuration information for receiving the control information of the beam, appropriate control information can be set.

Since the present embodiment further includes a transmission unit for transmitting response information to the reception of control information to the radio base station, it is possible to respond whether or not the control information from the base station has been received.

### (9) Other Embodiments

Although the contents of the present invention have been described by way of the embodiments, it is obvious to those skilled in the art that the present invention is not limited to what is written here and that various modifications and improvements thereof are possible.

For example, in the above embodiment, the terminal direction (down direction) from the radio base station is mainly described, but as described in the above embodiment, the radio signal in the radio base station direction (up direction) from the terminal may also be controlled.

In addition, the block configuration diagram (FIG. 3) used for the description of the above embodiment shows a block of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or radio) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions transmission is called a transmission unit (transmitting unit) or a transmitter. As described above, the method of realization of both is not particularly limited.

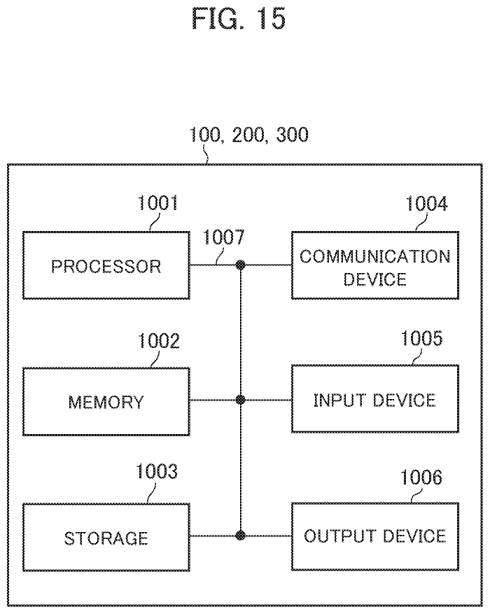

Furthermore, the UE200 and the radio relay device 300 described above may function as a computer for processing the radio communication method of the present disclosure. FIG. 15 is a diagram showing an example of a hardware configuration of the base station 100, the UE200 and the radio relay device 300. As shown in FIG. 15, the base station 100, the UE200 and the radio relay device 300 may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the radio relay device 300 (see FIG. 3) is implemented by any hardware element of the computer device or a combination of the hardware elements.

In addition, each or a part of the functions of the radio relay device 300 may be implemented by loading predetermined software (programs) onto hardware such as the processor 1001 and the memory 1002, whereby the processor 1001 performs operations to control communication by communication device 1004, or by controlling at least one of data reading and writing in the memory 1002 and the storage 1003.

The processor 1001, for example, operates an operating system to control the entire computer. The processor 1001 may be configured with a central processing unit (CPU) including interfaces to peripheral devices, controls, computing devices, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 may store a program (program code), a software module, or the like capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Information notification is not limited to the aspects/embodiments described in this disclosure and may be performed using other methods. For example, notification of information may be performed by physical layer signaling (e.g., Downlink Control Information (DCI), Uplink Control Information (UCI), higher layer signaling (e.g., RRC signaling, Medium Access Control (MAC) signaling,

Notification Information (Master Information Block (MIB), System Information Block (SIB)), other signals, or a combination thereof. RRC signaling may also be referred to as RRC messages, e.g., RRC Connection Setup messages, RRC Connection Reconfiguration messages, etc.

Each of the aspects/embodiments described in this disclosure may apply to at least one of systems utilizing Long Term Evolution (LTE), LTE-Advanced (LTE-A), SUPER 3G, IMT-Advanced, 4th generation mobile communication system (4G), 5th generation mobile communication system (5G), Beyond 5G, 6G, Future Radio Access (FRA), New Radio (NR), W-CDMA, GSM, CDMA2000, Ultra Mobile Broadband (UMB), IEEE 802.11 (Wi-Fi), IEEE 802.16 (WiMAX), IEEE 802.20, Ultra-WideBand (UWB), Bluetooth®, or any other suitable system, and next-generation systems extended thereunder. Further, a plurality of systems may be combined (for example, a combination of at least one of the LTE and the LTE-A with the 5G).

The processing procedures, sequences, flowcharts, etc. of the embodiments/embodiments described in the present disclosure may be rearranged as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars,), or a robot (manned or unmanned). At least one of a base station and a mobile station can be a device that does not necessarily move during the communication operation. For example, at least one of a base station and a mobile station may be an Internet of Things (IOT) device such as a sensor.

The base station in the present disclosure may be read as a mobile station (user terminal, hereinafter the s same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the mobile station in the present disclosure may be replaced with a base s station. In this case, the base station may have the function of the mobile station. A radio frame may be composed of one or more frames in the time domain. Each frame or frames in the time domain may be referred to as a subframe. A subframe may be further configured by one or more slots in the time domain. The subframe may be a fixed time length (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. A PDSCH (or PUSCH) transmitted in time units greater than a minislot may be referred to as a PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframe and the TTI may be a subframe (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain.

The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (SubCarrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to transmit and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure,

### EXPLANATION OF REFERENCE NUMERALS

10 radio communication system
100, 150 A to 150 D radio base station
200 UE
300 radio relay device
301 relay Antenna
303 variable unit
330 control unit
C cell
OB obstacle
1001 processor
1002 memory
1003 storage
1004 communication device
1005 input device
1006 output device
1007 bus

1. A radio relay device comprising:
a control unit that controls a relay state of at least a beam when radio waves from a radio base station or terminal are relayed without signal interpretation; and
a reception unit that receives control information from the radio base station, wherein
the control unit controls the relay state of the beam based on the control information.

2. The radio relay device according to claim 1, wherein the control unit determines whether the control information received by reception unit is addressed to the radio relay device.

3. The radio relay apparatus according to claim 1, wherein the control unit controls a time until the relay state of the beam is changed based on the control information.

4. The radio relay apparatus according to claim 1, wherein the control unit controls an application period of controlling the relay state of the beam based on the control information.

5. The radio relay apparatus according to claim 1, wherein the reception unit receives configuration information for receiving the control information of the beam.

6. The radio relay apparatus according to claim 1, further comprising a transmission unit that transmits response information responding reception of the control information to the radio base station.

7. A radio relay method comprising the steps of:
controlling a relay state of at least a beam when radio waves from a radio base station or terminal are relayed without signal interpretation; and
receiving control information from the radio base station, wherein
in the controlling step, the relay state of the beam is controlled based on the control information.

8. The radio relay apparatus according to claim 2, wherein the control unit controls a time until the relay state of the beam is changed based on the control information.

9. The radio relay apparatus according to claim 2, wherein the control unit controls an application period of controlling the relay state of the beam based on the control information.

10. The radio relay apparatus according to claim 2, wherein the reception unit receives configuration information for receiving the control information of the beam.

11. The radio relay apparatus according to claim 3, wherein the reception unit receives configuration information for receiving the control information of the beam.

12. The radio relay apparatus according to claim 4, wherein the reception unit receives configuration information for receiving the control information of the beam.

13. The radio relay apparatus according to claim 2, further comprising a transmission unit that transmits response information responding reception of the control information to the radio base station.

14. The radio relay apparatus according to claim 3, further comprising a transmission unit that transmits response information responding reception of the control information to the radio base station.

15. The radio relay apparatus according to claim 4, further comprising a transmission unit that transmits response information responding reception of the control information to the radio base station.

16. The radio relay apparatus according to claim 5, further comprising a transmission unit that transmits response information responding reception of the control information to the radio base station.
